(19) United States
(12) Patent Application Publication
(10) Pub. No.: US 2021/0090462 A1
(43) Pub. Date: Mar. 25, 2021

(54) PRESENTATION AND IMPLEMENTATION OF AN ELECTRONIC DEVICE BASED E-LEARNING PLATFORM

(71) Applicant: QIFT SOLUTECH PVT LTD, Bangalore (IN)

(72) Inventors: SRIDHER JEYACHANDRAN, Bangalore (IN); RATHINAMURTHY R, Bangalore (IN); BHAVANI CHANDRASEKARAN, Bangalore (IN)

(73) Assignee: QIFT SOLUTECH PVT LTD

(21) Appl. No.: 16/714,691

(22) Filed: Dec. 14, 2019

(30) Foreign Application Priority Data
Sep. 23, 2019 (IN) 201941038192

(51) Int. Cl. G09B 19/00; G06F 16/2457; G06F 16/23; G09B 7/04

(52) U.S. Cl. CPC G09B 19/0053; G09B 7/04; G06F 16/2379; G06F 16/24575

(57) ABSTRACT

An electronic device, includes a memory and a central processing unit. The memory store a first user profile of a user, and a difficulty level associated with the user. The CPU presents a first coding problem for the user, based on the stored first user profile of the user. Further, the CPU monitors a first user parameter of the user. The first user parameter corresponds to a first user attempt, by the user, to solve the presented first coding problem. The CPU predicts a subsequent user action of the user based on the monitored first parameter of the user and the first user profile of the user. The CPU generate a plurality of responses for the user based on the predicted subsequent action and the first user profile, wherein the plurality of responses corresponds to hints for the user to solve the presented first coding problem.

### FIELD OF INVENTION

Various embodiments of the disclosure relate to e-learning platforms. More specifically, various embodiments of the disclosure relate to an electronic device and a method for presentation of an e-learning platform to a user.

### BACKGROUND

Recent years have witnessed a growth spurt in the number of e-learning platforms available in the market. The e-learning platforms enable users to access media content, such as video files, audio files, image files, video streams, audio streams, podcasts, and other documents and thereby gain knowledge on various subjects. A course material provided by the e-learning platform may be of one or more difficulty levels.

In certain scenarios, a difficulty level of a first course material may be greater than a difficulty level that is optimal for a user. In such scenarios, it may be difficult for the user to grasp the concepts covered in the course material provided by the e-learning platform. Hence, the user may get frustrated with the e-learning platform and may lose interest.

In other scenarios, the difficulty level of the first course material may be lesser than the difficulty level that is optimal for the user. In such scenarios, the user may not be sufficiently challenged by the course material. Hence, the user may get bored with the course material covered by the e-learning platform and may lose interest.

In yet another scenario, the e-learning platform may educate the user solely based on text based and video based tutorials. In such scenarios, the e-learning platform fail to provide hands-on training to the user. It may be difficult for the user to grasp the practical side of the course material covered by the e-learning platform.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY OF THE INVENTION

An electronic device and method for presentation of an e-learning platform is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for presentation of an e-learning platform, in accordance with an embodiment of the disclosure.

FIG. 2 is a block diagram that illustrates an exemplary electronic device for presentation of an e-learning platform, in accordance with an embodiment of the disclosure.

FIG. 3 is a flowchart that illustrates an exemplary method for presentation of an e-learning platform to a user, in accordance with an embodiment of the disclosure.

FIG. 4 is a flow diagram that illustrates data flow in an e-learning platform, in accordance with an embodiment of the disclosure.

FIG. 5 is a flow diagram that illustrates data flow in an events repository of an e-learning platform, in accordance with an embodiment of the disclosure.

FIG. 6A and 6B illustrate output timings for a beginner user and an intermediate user of an e-learning platform, in accordance with an embodiment of the disclosure.

### DETAILED DESCRIPTION

The following described implementations may be found in the disclosed electronic device and method for presentation of an e-learning platform. Various embodiments of the disclosed electronic device and method enables a user to receive a plurality of personalized coding problems and get dynamically adjusted real-time assistance to solve the plurality of coding problems.

Exemplary aspects of the disclosure may include a first electronic device for presentation of an e-learning platform to a user. The first electronic device may comprise a memory and a Central Processing Unit (CPU). The memory may be configured to store a first user profile of a user, and a difficulty level associated with the user.

The CPU may be configured to present a first coding problem for the user, based on the stored first user profile of the user. The CPU may be further configured to monitor a first user parameter of the user. The first user parameter corresponds to a first user attempt, by the user, to solve the presented first coding problem. The CPU may be further configured to predict a subsequent user action of the user based on the monitored first parameter of the user and the first user profile of the user. The CPU may be further configured to generate a plurality of responses for the user based on the predicted subsequent action and the first user profile. The plurality of responses corresponds to hints for the user to solve the presented first coding problem.

The CPU may be configured to determine a plurality of output timings for output of the plurality of responses to the user. The plurality of output timings is determined based on the difficulty level associated with the user. The CPU may be further configured to output the plurality of responses at one or more output timings of the plurality of output timings based on the difficulty level associated with the user.

The CPU may be configured to analyze a second user parameter of the user. The second user parameter corresponds to a second user attempt of the user to solve the presented first coding problem. The second user attempt is made by the user after the CPU has outputted the plurality of responses to the user. The CPU may be further configured to determine a user progress level based on the analyzed second user parameter. The CPU may be further configured to dynamically modify the difficulty level associated with the user, based on the analyzed second user parameter. The CPU may be further configured to output the plurality of responses at one or more output timings of the plurality of output timings based on the modified difficulty level associated with the user.

The CPU may be configured to modify the first user profile based on the analyzed second user parameter. The CPU may be further configured to modify the first coding problem to generate a second coding problem based on the analyzed second user parameter, the difficulty level of the user, and the first user profile of the user. The first user profile comprises at least one baseline parameter value of the user. The CPU may be further configured to compare the first user parameter of the user with the baseline parameter value of the user. The CPU may be further configured to identify a first stress level and a first motivation level of the user based on a result of the comparison of the first user parameter of the user with the baseline parameter value of the user. The CPU may be further configured to compare the second user parameter of the user with the baseline parameter value of the user. The CPU may be further configured to identify a second stress level and a second motivation level of the user based on a result of the comparison of the second user parameter of the user with the baseline parameter value of the user.

The CPU may be configured to compare the first stress level and the first motivation level with the second stress level and the second motivation level of the user. The CPU may be further configured to optimize the difficulty level of the user based on a result of the comparison of the first stress level and the first motivation level with the second stress level and the second motivation level of the user. The CPU may be further configured to compare the first user parameter and the second user parameter. The CPU may be further configured to correlate the outputted plurality of responses with a result of the comparison. The CPU may be further configured to modify the first user profile based on the correlation.

The CPU may be configured to determine a behavior pattern of the user based on the correlation. The CPU may be further configured to generate a plurality of personalized responses for the user based on the correlation. Each personalized response of the plurality of personalized responses corresponds to the determined behavior pattern of the user. The CPU may be further configured to generate a plurality of personalized coding problems for the user based on the determined behavior pattern of the user.

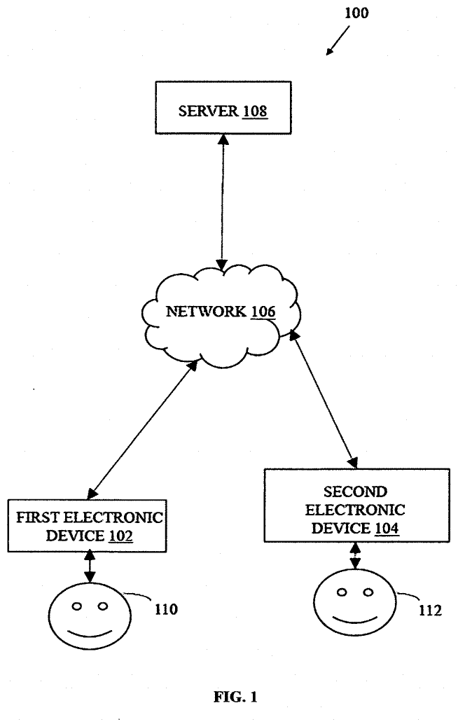

FIG. 1 is a block diagram that illustrates an exemplary network environment 100 for presentation of an e-learning platform, in accordance with an embodiment of the disclosure. With reference to FIG. 1, there is shown a network environment 100. The network environment 100 may include one or more electronic devices, such as a first electronic device 102 and a second electronic device 104, a communication network 106, one or more database servers, such as a server 108, and one or more users, such as a first user 110 and a second user 112. The first electronic device 102 may be associated with the first user 110. The second electronic device 104 may be associated with the second user 112. The first electronic device 102, the second electronic device 104, and the server 108 may be communicatively coupled to each other, via the communication network 106.

The first electronic device 102 and the second electronic device 104 may comprise suitable circuitry, interfaces, and/or code that may be configured to present a plurality of coding problems to the one or more users. The electronic device 102 and the second electronic device 104 may receive the plurality of coding problems from the server 108 via the communication network 106. The first electronic device 102 may be configured to receive, from the one or more users, a plurality of user inputs corresponding to a plurality of user attempts to solve the plurality of coding problems. The first electronic device 102 and the second electronic device 104 may further comprise a coding workspace which may be used by the one or more users to solve the plurality of coding problems. The coding workspace may comprise a plurality of hooks to capture a plurality of user parameters associated with the plurality of users. Examples of the plurality of user parameters may include, but is not limited to time spent by the one or more users to solve one or more coding problems. The plurality of user parameters may further include number of compile cycles executed by the one or more users in the process of solving the one or more coding problems. Examples of the first electronic device 102 and the second electronic device 104 may include, but are not limited to, a personal computer, a tablet computer, a smartphone, a laptop, a computer workstation, an augmented reality based device, a computing device, a server, and/or other consumer electronic (CE) devices.

The server 108 may comprise suitable circuitry, interfaces, and/or code that may be configured to store media content. Examples of the server 108 may include, but are not limited to, a database server, a file server, an application server, a cloud server, a web server, or a combination thereof. The server 108 may be configured to store a plurality of user profiles associated with the one or more users. Each user profile of the plurality of users may comprise a plurality of user details. The plurality of user details may include information associated with a user's learning progress, a user's motivation level, a user's knowledge level, and a user's proficiency level in coding. Each user profile of the plurality of user profiles may further comprise a baseline parameter value of each user of the one or more user. The server 108 may be configured to store the plurality of coding problems. The server 108 may be configured to store a difficulty level information associated with each user of the one or more users.

The communication network 106 may include a communication medium through which the first electronic device 102 and the second electronic device 104 may communicate with each other or with the server 108. Examples of the communication network 106 may include, but are not limited to, the Internet, a cloud network, a Wireless Fidelity (Wi-Fi) network, a Local Area Network (LAN), and/or a Metropolitan Area Network (MAN). Various devices in the network environment 100 may be configured to connect to the communication network 106, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, IEEE 802.11b, IEEE 802.11g, IEEE 802.11n, and/or any other IEEE 802.11 protocol, multi-hop communication, wireless access point (AP), device to device communication, cellular communication protocols, Light-fidelity (Li-Fi), Internet-of-Things (IoT) network, or Bluetooth (BT) communication protocols, or a combination or variants thereof.

In operation, the first electronic device 102 may be configured to present a first coding problem for the first user 110, based on a first user profile of the first user 110. In one example, the first coding problem may be a simulation of one or more stages of product development in a real-world scenario. The first electronic device 102 may be configured to receive a plurality of user inputs from the first user 110. The plurality of user inputs may correspond to a plurality of user attempts by the first user 110 to solve the first coding problem, in the coding workspace of the first electronic device 102. The first electronic device 102 may be configured to capture a first user parameter from the first user 110, as the first user 110 attempts to solve the first coding problem. In some embodiments, the first electronic device 102 may be configured to determine one or more learning outcomes for the first user 110 based on the first user profile of the first user 110. In such cases, the first coding problem may be presented based on the determined one or more learning outcomes of the first user 110.

The first electronic device 102 may be configured to monitor the first user parameter of the first user 110. The first electronic device 102 may be configured to compare the first user parameter with a baseline parameter value of the first user 110. The first electronic device 102 may be configured to determine a first stress level and a first motivation level of the first user 110, based on the comparison of the first user parameter of the first user 110, with a baseline parameter value of the first user 110. In one example, the first user parameter of the first user 110 corresponds to time spent by the first user 110 to complete one portion of the first coding problem. The baseline parameter value corresponds to an average amount of time spent by the first user 110 to complete each of the plurality of coding problems. In the case where the first user parameter is greater than the baseline parameter value, then the first stress level is determined to be greater than the first motivation level. In the case where the first user parameter is lesser than the baseline parameter value, then the first stress level is determined to be lesser than the first motivation level. In one example, the first electronic device 102 may be configured to dynamically adjust the difficulty level of the first coding problem based on the determined first stress level and the first motivation level. For example, the first electronic device 102 may be configured to determine that the first user 110 is unable to solve the first coding problem, based on the determined first stress level. In such scenarios, the first electronic device 102 may be configured to reduce the difficulty level of the first coding problem.

The first electronic device 102 may be configured to dynamically adjust the difficulty level to a desirable difficulty level of the user. When the difficulty level is greater than the desirable difficulty level, then the first user 110 may get stressed out in an attempt to solve the first coding problem. When the difficulty level is lower than the desirable difficulty level, then the first user 110 may get bored in an attempt to solve the first coding problem. The first user 110 may be interested to solve the first coding problem at the desirable difficulty level.

The first electronic device 102 may be configured to predict a subsequent user action of the first user 110 based on the monitored first parameter of the first user 110 and the first user profile of the first user 110. The predicted subsequent user action corresponds to a prediction of future user attempts to solve the first coding problem.

The first electronic device 102 may be configured to generate a plurality of responses for the first user 110 based on the predicted subsequent action and the first user profile. The plurality of responses corresponds to hints for the first user 110 to solve the presented first coding problem. Examples of the plurality of responses may include, but is not limited to a text-based hint, a video-based hint, an audio-based hint or a vibration-based hint.

The first electronic device 102 may be configured to determine a plurality of output timings for output of the plurality of responses to the first user 110. The plurality of output timings may be determined based on the difficulty level associated with the first user 110. The determined plurality of output timings associated with a low difficulty level, is more densely distributed in comparison with the determined plurality of output timings associated with a high difficulty level. Further, the first electronic device 102 may be configured to output the plurality of responses at one or more output timings of the plurality of output timings based on the difficulty level associated with the first user 110. For example, a first number of responses outputted for the low difficulty level is higher than a second number of responses outputted for the high difficulty level. The plurality of responses may be output via a web-socket or a desktop application in the first electronic device 102.

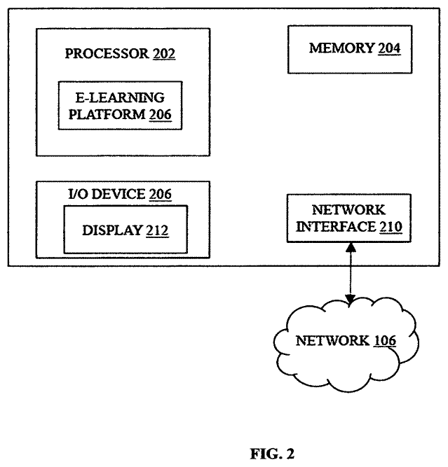

FIG. 2 is a block diagram that illustrates an exemplary electronic device for presentation of the e-learning platform, in accordance with an embodiment of the disclosure. FIG. 2 is explained in conjunction with elements from FIG. 1. With reference to FIG. 2, there is shown an exemplary electronic device, such as the first electronic device 102. The first electronic device 102 may include one or more processors, such as a processor 202, a memory 204, an I/O device 206, an e-learning platform 208, and a network interface 210. The I/O device 206 may include a display 212. The processor 202 may be communicatively coupled with the memory 204, the I/O device 206, the code embedder 208, and the network interface 210. The network interface 210 may be configured to communicate with the server 108, via the communication network 106.

The processor 202 may comprise suitable logic, circuitry, interfaces, and/or code that may be configured to execute a set of instructions stored in the memory 204. The processor 202 may be implemented based on a number of processor 202 technologies known in the art. In one example, the processor 202 may be a central processing unit (CPU). Other examples of the processor 202 may be an X86-based processor 202, a Reduced Instruction Set Computing (RISC) processor 202, an Application-Specific Integrated Circuit (ASIC) processor 202, a Complex Instruction Set Computing (CISC) processor 202, and/or other processors.

The memory 204 may comprise suitable logic, circuitry, and/or interfaces that may be configured to store a set of instructions executable by the processor 202. The memory 204 may be configured to store the plurality of coding problems and the plurality of user profiles. The memory 204 may be configured to store operating systems and associated applications. The memory 204 may be further configured to store various algorithms to detect face, gesture, shape, and/or edge. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The I/O device 206 may comprise suitable logic, circuitry, interfaces, and/or code that may be configured to receive an input from a user, such as the first user 110. The I/O device 206 may be further configured to provide an output to the first user 110. The I/O device 206 may comprise various input and output devices that may be configured to communicate with the processor 202. Examples of the input devices may include, but are not limited to, a touch screen, a keyboard, a mouse, a joystick, a microphone, and/or the image-capture unit. Examples of the output devices may include, but are not limited to, the display and/or a speaker.

The e-learning platform 208 may comprise suitable logic, circuitry, interfaces, and/or code that may be configured to perform one or more operations, such presenting the first coding problem to the first user 110. In one example, the e-learning platform 208 may be configured to present the coding workspace to the first user 110 to enable the first user 110 to attempt to solve the first coding problem.

The network interface 210 may comprise suitable logic, circuitry, interfaces, and/or code that may be configured to establish communication between the first electronic device 102, the second electronic device 104, and the server 108, via the communication network 106. The network interface 210 may be implemented by use of various known technologies to support wired or wireless communication of the first electronic device 102 with the communication network 106. The network interface 210 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer. The network interface 210 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VoIP), light fidelity (Li-Fi), Wi-MAX, a protocol for email, instant messaging, and/or Short Message Service (SMS).

The display 212 may comprise suitable logic, circuitry, interfaces, and/or code that may be configured to generate and render a user interface to receive input to set the one or more access control parameters, one or more user-preferences, and media content. In accordance with an embodiment, the display 212 may be able to receive input from the first user 110. In such a scenario, the display 212 may be a touch screen that enables the first user 110 to provide input. The touch screen may correspond to at least one of a resistive touch screen, a capacitive touch screen, or a thermal touch screen. In accordance with an embodiment, the display 212 may receive the input through a virtual keypad, a stylus, a gesture-based input, and/or a touch-based input. The display 212 may be realized through several known technologies such as, but are not limited to, at least one of a Liquid Crystal Display (LCD) display, a Light Emitting Diode (LED) display, a plasma display, and/or an Organic LED (OLED) display technology, and/or other display. In accordance with an embodiment, the display 212 may refer to a display screen of smart-glass device, a see-through display, a projection-based display, an electro-chromic display, and/or a transparent display.

In operation, the processor 202 may be configured to receive a second user parameter from the first user 110. The second user parameter corresponds to a second user attempt of the first user 110 to solve the presented first coding problem. The second user attempt is made by the first user 110 after the processor 202 has outputted the plurality of responses to the first user 110. The processor 202 may be configured to analyze the second user parameter of the first user 110.

The processor 202 may be configured to compare the second user parameter of the first user 110 with the baseline parameter value of the first user 110. The processor 202 may be configured to identify a second stress level and a second motivation level of the first user 110 based on a result of the comparison of the second user parameter of the first user 110 with the baseline parameter value of the first user 110. The processor 202 may be configured to determine a user progress level based on the analyzed second user parameter. Further, the processor 202 may be configured to dynamically modify the difficulty level associated with the first user 110, based on the analyzed second user parameter.

The processor 202 may be configured to output the plurality of responses at one or more output timings of the plurality of output timings based on the modified difficulty level associated with the first user 110. The processor 202 may be configured to modify the first user profile based on the analyzed second user parameter.

In some embodiments, the processor 202 may be configured to modify the first coding problem based on the analyzed second user parameter, the difficulty level of the first user 110, and the first user profile of the first user 110. For example, the processor 202 may be configured to divide the first coding problem into a plurality of sub-tasks. In such scenarios, the processor 202 may be configured to present the plurality of sub-tasks to the first user 110. The processor 202 may be further configured to adjust a content structure of the first coding problem based on the analyzed second parameter.

The processor 202 may be configured to compare the first stress level and the first motivation level with the second stress level and the second motivation level of the first user 110. Further, the processor 202 may be configured to optimize the difficulty level of the first user 110 based on a result of the comparison of the first stress level and the first motivation level with the second stress level and the second motivation level of the first user 110.

In some embodiments, the processor 202 may be configured to compare the first user parameter and the second user parameter. Further, the processor 202 may be configured to correlate the outputted plurality of responses with a result of the comparison. Furthermore, the processor 202 may be configured to modify the first user profile based on the correlation.

The processor 202 may be configured to determine a behavior pattern of the first user 110 based on the correlation. The processor 202 may be configured to generate a plurality of personalized responses for the first user 110 based on the correlation. Each personalized response of the plurality of personalized responses corresponds to the determined behavior pattern of the first user 110. The processor 202 may be configured to generate a plurality of personalized coding problems for the first user 110 based on the determined behavior pattern of the first user 110.

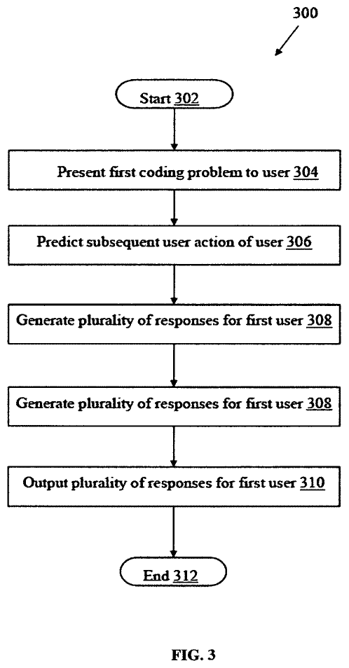

FIG. 3 depicts a flowchart that illustrates an exemplary method for presentation of an e-learning platform to a user, in accordance with one embodiment of the present disclosure. With reference to FIG. 3, there is shown a flow chart 300. The flow chart 300 is described in conjunction with elements from FIGS. 1 and 2. The method starts at 302 and proceeds to 304. The method shown in the flowchart 300 is implemented in the first electronic device 102.

At 302, the first coding problem may be presented for the first user 110, based on a first user profile of the first user 110. The processor 202 may be configured to present the first coding problem. In some embodiments, the first electronic device 102 may be configured to determine one or more learning outcomes for the first user 110 based on the first user profile of the first user 110.

At 304, the first user parameter of the first user 110 may be monitored by the processor 202. The first electronic device 102 may be configured to compare the first user parameter with a baseline parameter value of the first user 110. The first electronic device 102 may be configured to determine a first stress level and a first motivation level of the first user 110, based on the comparison of the first user parameter of the first user 110, with the baseline parameter value of the first user 110.

At 306, the subsequent user action of the first user 110 may be predicted by the processor 202, based on the monitored first parameter of the first user 110 and the first user profile of the first user 110. The predicted subsequent user action corresponds to the prediction of future user attempts, of the first user 110, to solve the first coding problem.

At 308, the plurality of responses for the first user 110 may be generated by the processor 202 based on the predicted subsequent action and the first user profile. The plurality of responses corresponds to hints for the first user 110 to solve the presented first coding problem. The first electronic device 102 may be configured to determine the plurality of output timings for output of the plurality of responses to the first user 110. The plurality of output timings may be determined based on the difficulty level associated with the first user 110. The determined plurality of output timings associated with a low difficulty level, is more densely distributed in comparison with the determined plurality of output timings associated with a high difficulty level.

At 310, the plurality of responses may be outputted by the processor 202 at one or more output timings of the plurality of output timings based on the difficulty level associated with the first user 110. For example, the first number of responses outputted for the low difficulty level is higher than the second number of responses outputted for the high difficulty level. The control may pass to end at 312.

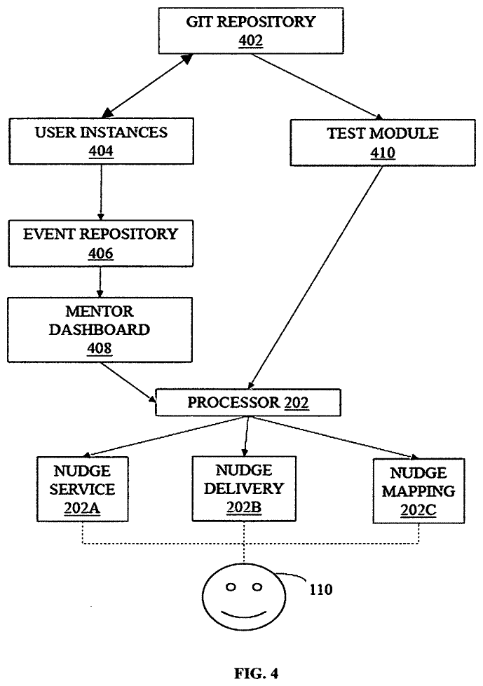

FIG. 4 is a flow diagram that illustrates data flow in an e-learning platform, in accordance with an embodiment of the disclosure. With reference to FIG. 4, there is shown a flow diagram. The flow diagram is described in conjunction with elements from FIGS. 1 and 2.

At 404, the e-learning platform 206 receives a plurality of user inputs from the plurality of users of the e-learning platform 206. The plurality of user inputs may correspond to user attempts by the plurality of users to solve a plurality of coding problems. In one example, the plurality of user inputs may include programming code input by the first user 110 to the first electronic device 102. The e-learning platform 206 may be configured to generate a plurality of user parameters from the plurality of user inputs. For example, the e-learning platform 206 may be configured to built logs, collect results of compile cycles, and collect test run logs based on the received programming code. The plurality of user inputs may further correspond to a plurality of coding sessions attended by the plurality of users. The plurality of coding sessions may be synchronized with a GIT repository 402. The GIT repository 402 may be configured to store a plurality of user commits and a plurality of backup commits for the plurality of users. The e-learning platform 406 may be further configured to generate details of a plurality of events associated with the plurality of coding sessions. The plurality of events may include a plurality of coding errors committed by the plurality of users.

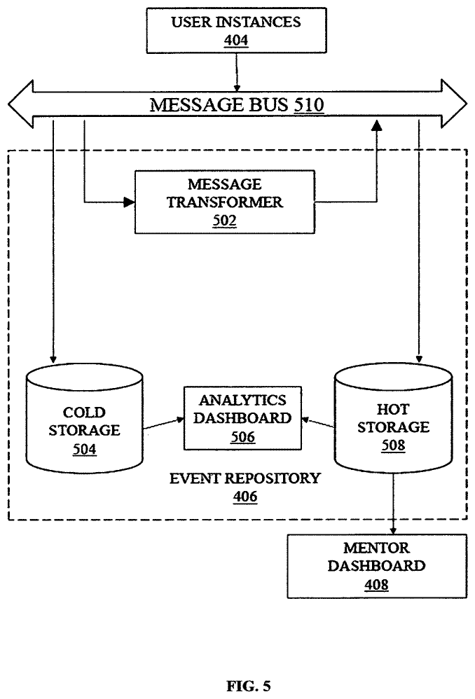

Referring to FIG. 5, the plurality of events are transmitted via a message bus 510, to an event repository 406. The event repository 406 may comprise a message transformer 502, a cold storage 504, an analytics dashboard 506, and a hot storage 508.

The message transformer 502 may be configured to cluster common errors from the plurality of events. A first set of events may be transmitted to the cold storage 504. The cold storage 504 may correspond to a data lake comprising raw, unstructured data associated with the plurality of events. The cold storage 504 may comprise historical data associated with the plurality of events. A second set of events may be transmitted to the hot storage 508. The hot storage 508 may comprise caches, time series databases, and NoSQL databases. The hot storage 508 may comprise structured data associated with the plurality of events. The analytics dashboard 506 may be configured to perform data analytics operations on the cold storage 504 and the hot storage 508. The hot storage 508 may be accessible by the mentor dashboard 408 via an application program interface (API) layer.

Referring back to FIG. 4, the test module 410 performs testing on the programming code input by the plurality of users. The test module 410 may be configured to perform a plurality of tests such as unit tests, stress tests, and integration tests on the programming code. The test module 410 may notify the first user 11 of success or failure of such tests. The test module 410 may be configured to generate a user build report. The generated user build report may be transmitted to the processor 202. The processor 202 may be configured to determine the optimal difficulty level for the first user 110 based on the plurality of user parameters such as user progress and user active time. The processor 202 may be configured to generate the plurality of responses (or nudges) corresponding to the plurality of events generated by the first user 110. The processor 202 may be configured to output the plurality of responses (Nudges) to the first user 110 via a nudge service module 202A, a nudge delivery module 202B, and a nudge mapping module 202C. The processor 202 may be configured to output the plurality of responses to the first user 110 further based on a manual trigger received from a mentor of the first user 110, via the mentor dashboard 408.

In accordance with one embodiment of the present disclosure, a first electronic device (such as the first electronic device 102 (FIG. 1)) for presentation of an e-learning platform to a user is disclosed. The first electronic device 102 may comprise a memory (such as the memory 204 (FIG. 2)) and a Central Processing Unit (CPU) (such as the processor 202 (FIG. 2)). The memory 204 may be configured to store a first user profile of a user, and a difficulty level associated with the user.

The CPU 202 may be configured to present a first coding problem for the user, based on the stored first user profile of the user. The CPU 202 may be further configured to monitor a first user parameter of the user. The first user parameter corresponds to a first user attempt, by the user, to solve the presented first coding problem. The CPU 202 may be further configured to predict a subsequent user action of the user based on the monitored first parameter of the user and the first user profile of the user. The CPU 202 may be further configured to generate a plurality of responses for the user based on the predicted subsequent action and the first user profile. The plurality of responses corresponds to hints for the user to solve the presented first coding problem.

The CPU 202 may be configured to determine a plurality of output timings for output of the plurality of responses to the user. The plurality of output timings is determined based on the difficulty level associated with the user. The CPU 202 may be further configured to output the plurality of responses at one or more output timings of the plurality of output timings based on the difficulty level associated with the user. The CPU 202 may be configured to analyze a second user parameter of the user. The second user parameter corresponds to a second user attempt of the user to solve the presented first coding problem. The second user attempt is made by the user after the CPU 202 has outputted the plurality of responses to the user. The CPU 202 may be further configured to determine a user progress level based on the analyzed second user parameter. The CPU 202 may be further configured to dynamically modify the difficulty level associated with the user, based on the analyzed second user parameter. The CPU 202 may be further configured to output the plurality of responses at one or more output timings of the plurality of output timings based on the modified difficulty level associated with the user. The determined plurality of output timings associated with a low difficulty level, is more densely distributed in comparison with the determined plurality of output timings associated with a high difficulty level.

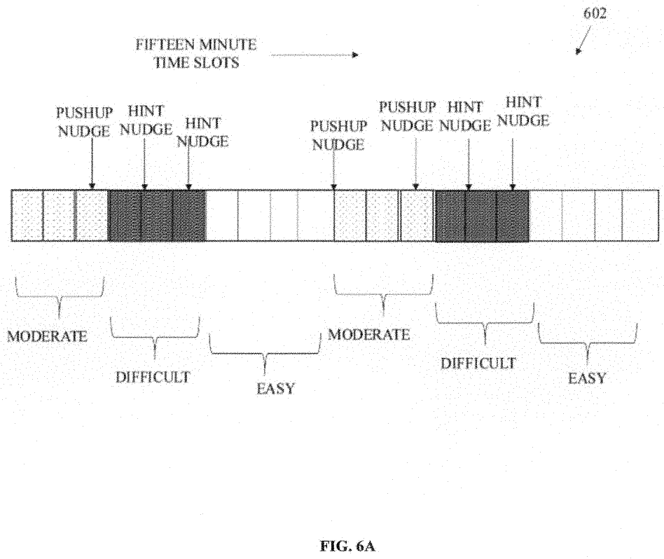

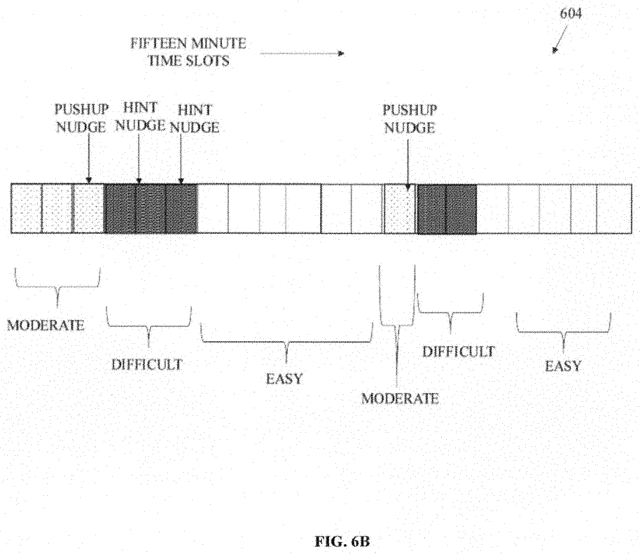

FIG. 6A illustrates a first timeline 602 for responses associated with a beginner user. The plurality of responses comprises pushup nudges and hint nudges. The hint nudges comprise hints and clues to ease the difficulty level for the user. The pushup nudges comprise riddles and challenges which increase the difficulty level for the user. Each block in the first timeline 602 represents a fifteen minute time interval. FIG. 6A further illustrates three difficulty levels for the user: an easy difficulty level, a moderate difficulty level, and a difficult difficulty level. The user may be capable of easily solving the first coding problem at the easy difficulty level. The user may experience moderate difficulty while attempting to solve the first coding problem at the moderate difficulty level. The user may struggle to solve the first coding problem at the difficult difficulty level.

The CPU 202 may be configured to output the plurality of the responses such that the user experiences a balanced combination of the easy, moderate, and the difficult difficulty levels. For example, based on a stress level and a motivation level of the user, the CPU 202 may determine that the user is attempting to solve the coding problem at the moderate difficulty level. In such cases, the CPU 202 may be configured to output a pushup nudge to increase the difficulty level of the user to the difficult difficulty level. The user may struggle to solve the first coding problem at the difficult difficulty level. The CPU may be configured to analyze the stress level and the motivation level of the user to detect that the user is attempting to solve the first coding problem at the difficult difficulty level. In such cases, the CPU 202 may output a number of hint nudges to reduce the difficulty level of the user, to the easy difficulty level. Therefore, the CPU 202 dynamically adjusts the difficulty level of the user such that the user experiences an optimal combination of the easy, the moderate, and the difficult difficulty levels and thus, is enabled to solve the first coding problem at desirable difficulty levels.

Similarly, FIG. 6B illustrates a second timeline 604 for responses associated with an intermediate user. In comparison with the beginner user, the intermediate user may require a lesser number of hint nudges and pushup nudges. The CPU 202 may be configured to output the hint nudges and the pushup nudges such that the intermediate user experiences an optimal combination of the easy difficulty level, the moderate difficulty level, and the difficult difficulty level.

Various embodiments of the disclosure may provide another non-transitory computer readable medium and/or storage medium, where there is stored therein, a set of instructions executable by a machine and/or a computer for presentation of an e-learning platform to a user. The set of instructions may cause the machine and/or computer to perform operations that comprise presenting a first coding problem for the user, based on the stored first user profile of the user. The operations may further comprise monitoring a first user parameter of the user, predicting a subsequent user action of the user based on the monitored first parameter of the user and the first user profile of the user, generating a plurality of responses for the user based on the predicted subsequent action and the first user profile. The operations further comprise determining a plurality of output timings for output of the plurality of responses to the user, and outputting the plurality of responses at one or more output timings of the plurality of output timings based on the difficulty level associated with the user.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departure from the scope of the present disclosure. In addition, many modifications may be made to adapt a particular situation or material to the teachings of the present disclosure without departure from its scope. Therefore, it is intended that the present disclosure not be limited to the particular embodiment disclosed, but that the present disclosure will include all embodiments that fall within the scope of the appended claims.

We claim:

1. An electronic device, comprising:
a memory configured to store a first user profile of a user, and a difficulty level associated with the user; and
a central processing unit (CPU) configured to:
present a first coding problem for the user, based on the stored first user profile of the user;
monitor a first user parameter of the user, wherein the first user parameter corresponds to a first user attempt, by the user, to solve the presented first coding problem;
predict a subsequent user action of the user based on the monitored first parameter of the user and the first user profile of the user;
generate a plurality of responses for the user based on the predicted subsequent action and the first user profile, wherein the plurality of responses corresponds to hints for the user to solve the presented first coding problem;
determine a plurality of output timings for output of the plurality of responses to the user, wherein the plurality of output timings is determined based on the difficulty level associated with the user; and
output the plurality of responses at one or more output timings of the plurality of output timings based on the difficulty level associated with the user.

2. The electronic device according to claim 1, wherein the CPU is further configured to:
analyze a second user parameter of the user, wherein
the second user parameter corresponds to a second user attempt of the user to solve the presented first coding problem, and
the second user attempt is made by the user after the CPU has outputted the plurality of responses to the user;
determine a user progress level based on the analyzed second user parameter;
dynamically modify the difficulty level associated with the user, based on the analyzed second user parameter; and
output the plurality of responses at one or more output timings of the plurality of output timings based on the modified difficulty level associated with the user.

3. The electronic device according to claim 2, wherein the CPU is further configured to modify the first user profile based on the analyzed second user parameter.

4. The electronic device according to claim 2, wherein the CPU is further configured to modify the first coding problem to generate a second coding problem based on the analyzed second user parameter, the difficulty level of the user, and the first user profile of the user.

5. The electronic device according to claim 1, wherein the first user profile comprises at least one baseline parameter value of the user, and the CPU is further configured to:
compare the first user parameter of the user with the baseline parameter value of the user; and
identify a first stress level and a first motivation level of the user based on a result of the comparison of the first user parameter of the user with the baseline parameter value of the user.

6. The electronic device according to claim 5, wherein the CPU is further configured to:
compare the second user parameter of the user with the baseline parameter value of the user; and
identify a second stress level and a second motivation level of the user based on a result of the comparison of the second user parameter of the user with the baseline parameter value of the user.

7. The electronic device according to claim 6, wherein the CPU is further configured to:
compare the first stress level and the first motivation level with the second stress level and the second motivation level of the user; and
optimize the difficulty level of the user based on a result of the comparison of the first stress level and the first motivation level with the second stress level and the second motivation level of the user.

8. The electronic device according to claim 1, wherein the CPU is further configured to:
compare the first user parameter and the second user parameter;
correlate the outputted plurality of responses with a result of the comparison; and
modify the first user profile based on the correlation.

9. The electronic device according to claim 8, wherein the CPU is further configured to
determine a behavior pattern of the user based on the correlation;
generate a plurality of personalized responses for the user based on the correlation, wherein each personalized response of the plurality of personalized responses corresponds to the determined behavior pattern of the user.

10. The electronic device according to claim 9, wherein the CPU is further configured to
generate a plurality of personalized coding problems for the user based on the determined behavior pattern of the user.

11. An method to present an e-learning platform, comprising:
storing a first user profile of a user, and a difficulty level associated with the user;
presenting a first coding problem for the user, based on the stored first user profile of the user;
monitoring a first user parameter of the user, wherein the first user parameter corresponds to a first user attempt, by the user, to solve the presented first coding problem;
predicting a subsequent user action of the user based on the monitored first parameter of the user and the first user profile of the user;
generating a plurality of responses for the user based on the predicted subsequent action and the first user profile, wherein the plurality of responses corresponds to hints for the user to solve the presented first coding problem;
determining a plurality of output timings for output of the plurality of responses to the user, wherein the plurality of output timings is determined based on the difficulty level associated with the user; and
outputting the plurality of responses at one or more output timings of the plurality of output timings based on the difficulty level associated with the user.

12. The method according to claim 11, further comprising:
analyzing a second user parameter of the user, wherein
the second user parameter corresponds to a second user attempt of the user to solve the presented first coding problem, and
the second user attempt is made by the user after the CPU has outputted the plurality of responses to the user;
determining a user progress level based on the analyzed second user parameter;
dynamically modifying the difficulty level associated with the user, based on the analyzed second user parameter; and
outputting the plurality of responses at one or more output timings of the plurality of output timings based on the modified difficulty level associated with the user.

13. The method according to claim 12, further comprising modifying the first user profile based on the analyzed second user parameter.

14. The method according to claim 12, further comprising modifying the first coding problem to generate a second coding problem based on the analyzed second user parameter, the difficulty level of the user, and the first user profile of the user.

15. The method according to claim 11, wherein the first user profile comprises at least one baseline parameter value of the user, and wherein the method further comprises:
comparing the first user parameter of the user with the baseline parameter value of the user; and
identifying a first stress level and a first motivation level of the user based on a result of the comparison of the first user parameter of the user with the baseline parameter value of the user.

16. The method according to claim 15, further comprising:
comparing the second user parameter of the user with the baseline parameter value of the user; and
identifying a second stress level and a second motivation level of the user based on a result of the comparison of the first user parameter of the user with the baseline parameter value of the user.

17. The method according to claim 16, further comprising:
comparing the first stress level and the first motivation level with the second stress level and the second motivation level of the user; and
optimizing the difficulty level of the user based on a result of the comparison of the first stress level and the first motivation level with the second stress level and the second motivation level of the user.

18. The method according to claim 11, wherein the CPU is further configured to:
comparing the first user parameter and the second user parameter;
correlating the outputted plurality of responses with a result of the comparison; and
modifying the first user profile based on the correlation.

19. The method according to claim 18, further comprising
determining a behavior pattern of the user based on the correlation;
generating a plurality of personalized responses for the user based on the correlation, wherein each personalized response of the plurality of personalized responses corresponds to the determined behavior pattern of the user.

20. The method according to claim 19, further comprising generating a plurality of personalized coding problems for the user based on the determined behavior pattern of the user.
